(19) United States
(12) Patent Application Publication
(10) Pub. No.: US 2026/0154612 A1
(43) Pub. Date: Jun. 4, 2026

(54) FUSING SENSOR DATA FROM MULTIPLE VEHICLES

(71) Applicant: GM Global Technology Operations LLC, Detroit, MI (US)

(72) Inventors: Wenyuan Qi, Shanghai (CN); Tianxiang Cao, Shanghai (CN); Zhengyu Xing, Shanghai (CN)

(21) Appl. No.: 18/973,420

(22) Filed: Dec. 9, 2024

(30) Foreign Application Priority Data
Dec. 4, 2024 (CN) 202411773335.7

(51) Int. Cl. G06N 20/00

(52) U.S. Cl. CPC G06N 20/00

(57) ABSTRACT

A method for fusing data from one or more vehicles includes capturing sensor data using one or more vehicle sensors. The method further may include transmitting the sensor data to a remote system. The sensor data is transmitted as tokenized data based at least in part on one or more features identified in the sensor data. The method further may include receiving the tokenized data from the one or more vehicles using the remote system. The method further may include fusing the tokenized data from the one or more vehicles using the remote system. Fusing the tokenized data further may include identifying at least one of: an important sensor type and an important feature and transmitting at least one of: the important sensor type and the important feature to the one or more vehicles.

### INTRODUCTION

The present disclosure relates to systems and methods for sensor data gathering, transmission, and fusion from multiple vehicle sources.

To enhance situational awareness and coordination, connected vehicles may be equipped with advanced sensor systems that gather and transmit data from various sources to assist in monitoring the environment and improving driving decisions. These sensor systems may include cameras, radar, LiDAR, ultrasonic sensors, and/or the like. Connected vehicles may use wireless communication networks to share data with nearby vehicles, infrastructure, and/or remote backend servers. Data from multiple vehicle sources may be combined, or “fused,” to provide a more complete view of the environment. For example, fused data may allow vehicles to perceive objects that would otherwise be obstructed by environmental features using data from other vehicles which are unobstructed. However, current data aggregation and fusion systems and methods may require a large amount of network bandwidth for transfer of sensor data between vehicles, infrastructure, and/or remote backend systems.

Thus, while current data gathering systems and methods achieve their intended purpose, there is a need for new and improved systems and methods for fusing data from one or more vehicles.

### SUMMARY

According to several aspects, a method for fusing data from one or more vehicles is provided. The method may include capturing sensor data using one or more vehicle sensors. The method further may include transmitting the sensor data to a remote system. The sensor data is transmitted as tokenized data based at least in part on one or more features identified in the sensor data. The method further may include receiving the tokenized data from the one or more vehicles using the remote system. The method further may include fusing the tokenized data from the one or more vehicles using the remote system.

In another aspect of the present disclosure, transmitting the sensor data further may include identifying one or more features in the sensor data using a feature extraction algorithm. Transmitting the sensor data further may include tokenizing the sensor data based at least in part on the one or more features.

In another aspect of the present disclosure, tokenizing the sensor data further may include determining an importance level of the sensor data using a data importance classification machine learning model. Tokenizing the sensor data further may include tokenizing the sensor data based at least in part on the importance level of the sensor data.

In another aspect of the present disclosure, determining the importance level further may include determining the importance level of the sensor data using the data importance classification machine learning model based at least in part on at least one of: the one or more features in the sensor data, a sensor type of the sensor data, and a road configuration in the sensor data.

In another aspect of the present disclosure, tokenizing the sensor data based at least in part on the importance level of the sensor data further may include tokenizing the sensor data based at least in part on the importance level of the sensor data. A size of the tokenized data varies directly with the importance level of the sensor data.

In another aspect of the present disclosure, receiving the tokenized data further may include generating detokenized data by detokenizing the tokenized data using a database of known features.

In another aspect of the present disclosure, fusing the tokenized data further may include combining the detokenized data received from multiple vehicles to aggregate combined detokenized data. Fusing the tokenized data further may include identifying at least one of: an important sensor type and an important feature based at least in part on the combined detokenized data. Fusing the tokenized data further may include transmitting at least one of: the important sensor type and the important feature to the one or more vehicles.

In another aspect of the present disclosure, combining the detokenized data further may include combining the detokenized data received from multiple vehicles using a data fusion machine learning model trained to fuse data captured in various environmental conditions from multiple vehicles.

In another aspect of the present disclosure, identifying at least one of: the important sensor type and the important feature based at least in part on the combined detokenized data further may include identifying at least one of: the important sensor type and the important feature based at least in part on the combined detokenized data using a sensor and feature importance classification machine learning model trained to identify the important sensor type and the important feature based at least in part on the combined detokenized data.

In another aspect of the present disclosure, determining the importance level further may include determining the importance level of the sensor data using the data importance classification machine learning model based at least in part on at least one of: the important sensor type and the important feature.

According to several aspects, a system for fusing data from one or more vehicles is provided. The system may include one or more vehicle systems, each of the one or more vehicle systems including one or more vehicle sensors, a vehicle communication system, and a vehicle controller in electrical communication with the one or more vehicle sensors and the vehicle communication system. The vehicle controller is programmed to capture sensor data using one or more vehicle sensors. The vehicle controller is further programmed to transmit the sensor data to a remote system using the vehicle communication system. The sensor data is transmitted as tokenized data based at least in part on one or more features identified in the sensor data.

In another aspect of the present disclosure, the system further includes the remote system including a remote system communication system and a remote system controller in electrical communication with the remote system communication system. The remote system controller is programmed to receive the tokenized data from the one or more vehicles using the remote system communication system. The remote system controller is further programmed to fuse the tokenized data from the one or more vehicles.

In another aspect of the present disclosure, to transmit the sensor data, the vehicle controller is further programmed to identify one or more features in the sensor data using a feature extraction algorithm. To transmit the sensor data, the vehicle controller is further programmed to determine an importance level of the sensor data using a data importance classification machine learning model based at least in part on at least one of: the one or more features in the sensor data, a sensor type of the sensor data, and a road configuration in the sensor data. To transmit the sensor data, the vehicle controller is further programmed to tokenize the sensor data based at least in part on the importance level of the sensor data. A size of the tokenized data varies directly with the importance level of the sensor data.

In another aspect of the present disclosure, to fuse the tokenized data, the remote system controller is further programmed to generate detokenized data by detokenizing the tokenized data using a database of known features. To fuse the tokenized data, the remote system controller is further programmed to combine the detokenized data received from multiple vehicles to aggregate combined detokenized data. To fuse the tokenized data, the remote system controller is further programmed to identify at least one of: an important sensor type and an important feature based at least in part on the combined detokenized data. To fuse the tokenized data, the remote system controller is further programmed to transmit at least one of: the important sensor type and the important feature to the one or more vehicle systems using the remote system communication system.

In another aspect of the present disclosure, to combine the detokenized data, the remote system controller is further programmed to combine the detokenized data received from multiple vehicles using a data fusion machine learning model trained to fuse data captured in various environmental conditions from multiple vehicles.

In another aspect of the present disclosure, to identify at least one of: the important sensor type and the important feature based at least in part on the combined detokenized data, the remote system controller is further programmed to identify at least one of: the important sensor type and the important feature based at least in part on the combined detokenized data using a sensor and feature importance classification machine learning model trained to identify the important sensor type and the important feature based at least in part on the combined detokenized data.

In another aspect of the present disclosure, to determine the importance level, the vehicle controller is further programmed to receive at least one of: the important sensor type and the important feature from the remote system using the vehicle communication system. To determine the importance level, the vehicle controller is further programmed to determine the importance level of the sensor data using the data importance classification machine learning model based at least in part on at least one of: the important sensor type and the important feature.

According to several aspects, a method for fusing data from one or more vehicles is provided. The method may include capturing sensor data using one or more vehicle sensors. The method further may include identifying one or more features in the sensor data using a feature extraction algorithm. The method further may include determining an importance level of the sensor data using a data importance classification machine learning model based at least in part on at least one of: the one or more features in the sensor data, a sensor type of the sensor data, and a road configuration in the sensor data and based at least in part on at least one of: an important sensor type and an important feature received from a remote system. The method further may include generating tokenized data by tokenizing the sensor data based at least in part on the importance level of the sensor data. The method further may include transmitting the tokenized data to the remote system. The method further may include identifying at least one of: the important sensor type and the important feature based at least in part on the tokenized data using the remote system. The method further may include transmitting at least one of: the important sensor type and the important feature to the one or more vehicles using the remote system.

In another aspect of the present disclosure, generating the tokenized data further may include tokenizing the sensor data based at least in part on the importance level of the sensor data. A size of the tokenized data varies directly with the importance level of the sensor data.

In another aspect of the present disclosure, identifying at least one of: the important sensor type and the important feature further may include generating detokenized data by detokenizing the tokenized data using a database of known features. Identifying at least one of: the important sensor type and the important feature further may include combining the detokenized data received from multiple vehicles to aggregate combined detokenized data. Identifying at least one of: the important sensor type and the important feature further may include identifying at least one of: the important sensor type and the important feature using a sensor and feature importance classification machine learning model trained to identify the important sensor type and the important feature based at least in part on the combined detokenized data.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for fusing data from one or more vehicles, according to an exemplary embodiment; and

FIG. 2 is a flowchart of a method for fusing data from one or more vehicles, according to an exemplary embodiment.

### DETAILED DESCRIPTION

The following description is merely exemplary in nature and is not intended to limit the present disclosure, application, or uses.

In aspects of the present disclosure, it is advantageous to aggregate and fuse sensor data from multiple nearby vehicles in an environment to acquire a more complete understanding of the conditions. However, transmission of sensor data may result in intensive resource use (e.g., transmission bandwidth and/or processing power). Accordingly, the present disclosure provides a new and improved system and method for efficiently fusing data from one or more vehicles.

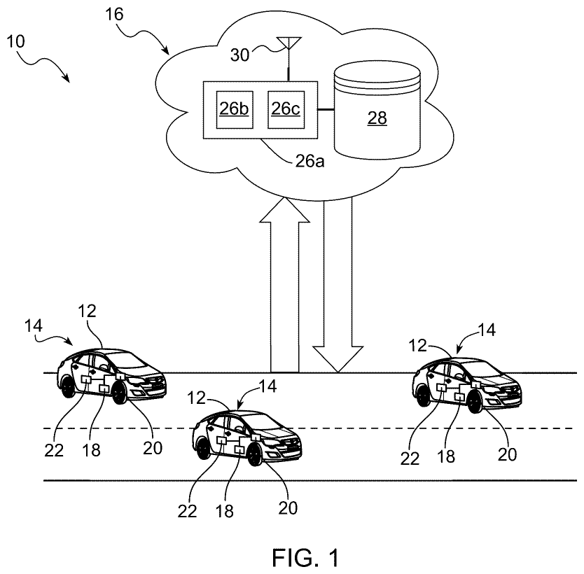

Referring to FIG. 1, a schematic diagram of a system 10 for fusing data from one or more vehicles is shown. The system 10 includes one or more vehicles 12, each of the one or more vehicles 12 including a vehicle system 14. The system 10 further includes a remote system 16.

The vehicle system 14 includes a vehicle controller 18, one or more vehicle sensors 20, and a vehicle communication system 22.

The vehicle controller 18 is used to implement a method 100 for fusing data from one or more vehicles, as will be described below. The vehicle controller 18 includes at least one processor and a non-transitory computer readable storage device or media. The processor may be a custom made or commercially available processor, a central processing unit (CPU), a graphics processing unit (GPU), an auxiliary processor among several processors associated with the vehicle controller 18, a semiconductor-based microprocessor (in the form of a microchip or chip set), a macroprocessor, a combination thereof, or generally a device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 18 to control various systems of the one or more vehicles 12.

The vehicle controller 18 may also include multiple controllers which are in electrical communication with each other. The vehicle controller 18 may be inter-connected with additional systems and/or controllers of the one or more vehicles 12, allowing the vehicle controller 18 to access data such as, for example, speed, acceleration, braking, and steering angle of the one or more vehicles 12.

The vehicle controller 18 is in electrical communication with the one or more vehicle sensors 20 and the vehicle communication system 22. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the vehicle controller 18 are within the scope of the present disclosure.

The one or more vehicle sensors 20 are used to acquire data about an environment surrounding the one or more vehicles 12. In the scope of the present disclosure, telemetry data includes, for example, engine RPM, vehicle speed, fuel level, engine temperature, odometer reading, battery voltage, brake system status, transmission data, tire pressure, GNSS location, acceleration and deceleration, steering angle, suspension system data, exhaust emission levels, diagnostic trouble codes (DTCs), airbag status, windshield wiper status, lights and indicators, and cruise control status. In an exemplary embodiment, the one or more vehicle sensors 20 includes sensors to determine performance data about the one or more vehicles 12. In a non-limiting example, the one or more vehicle sensors 20 further includes at least one of: a motor speed sensor, a motor torque sensor, an electric drive motor voltage and/or current sensor, an accelerator pedal position sensor, a brake position sensor, a coolant temperature sensor, a cooling fan speed sensor, a wheel speed sensor, and a transmission oil temperature sensor.

In another exemplary embodiment, the one or more vehicle sensors 20 further includes sensors to determine information about an environment within the one or more vehicles 12. In a non-limiting example, the one or more vehicle sensors 20 further includes at least one of a seat occupancy sensor, a cabin air temperature sensor, a cabin motion detection sensor, a cabin camera, a cabin microphone, and/or the like.

In another exemplary embodiment, the one or more vehicle sensors 20 further includes sensors to determine information about the environment surrounding the one or more vehicles 12. In a non-limiting example, the one or more vehicle sensors 20 further includes at least one of: an ambient air temperature sensor, a barometric pressure sensor, a global navigation satellite system (GNSS), and/or a photo and/or video camera which is positioned to view the environment in front of the one or more vehicles 12.

The GNSS is used to determine a geographical location of the one or more vehicles 12. In an exemplary embodiment, the GNSS is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the one or more vehicles 12 based on the signals received by the GPS receiver antenna. In an exemplary embodiment, the GNSS additionally includes a map. The map includes information about infrastructure such as municipality borders, roadways, railways, sidewalks, buildings, and the like. Therefore, the geographical location of the one or more vehicles 12 is contextualized using the map information. In a non-limiting example, the map is retrieved from a remote source using a wireless connection. In another non-limiting example, the map is stored in a database of the GNSS. It should be understood that various additional types of satellite-based radionavigation systems, such as, for example, the Global Positioning System (GPS), Galileo, GLONASS, and the BeiDou Navigation Satellite System (BDS) are within the scope of the present disclosure. It should be understood that the GNSS may be integrated with the vehicle controller 18 (e.g., on a same circuit board with the vehicle controller 18 or otherwise a part of the vehicle controller 18) without departing from the scope of the present disclosure.

In another exemplary embodiment, at least one of the one or more vehicle sensors 20 is a perception sensor capable of perceiving objects and/or measuring distances in the environment surrounding the one or more vehicles 12. In a non-limiting example, the one or more vehicle sensors 20 includes a stereoscopic camera having distance measurement capabilities. In one example, at least one of the one or more vehicle sensors 20 is affixed inside of the one or more vehicles 12, for example, in a headliner of the one or more vehicles 12, having a view through a windscreen of the one or more vehicles 12. In another example, at least one of the one or more vehicle sensors 20 is affixed outside of the one or more vehicles 12, for example, on a roof of the one or more vehicles 12, having a view of the environment surrounding the one or more vehicles 12. It should be understood that various additional types of perception sensors, such as, for example, LiDAR sensors, ultrasonic ranging sensors, radar sensors, and/or time-of-flight sensors are within the scope of the present disclosure. The one or more vehicle sensors 20 are in electrical communication with the vehicle controller 18 as discussed above.

The vehicle communication system 22 is used by the vehicle controller 18 to communicate with other systems external to the one or more vehicles 12. For example, the vehicle communication system 22 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the one or more vehicles 12 and any remote system (e.g., vehicles, infrastructure, and/or remote systems). In certain embodiments, the vehicle communication system 22 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 22 may further include an embedded universal integrated circuit card (eUICC) configured to store at least one cellular connectivity configuration profile, for example, an embedded subscriber identity module (eSIM) profile.

The vehicle communication system 22 is further configured to communicate via a personal area network (e.g., BLUETOOTH) and/or near-field communication (NFC). However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 22 may include one or more antennas and/or communication transceivers for receiving and/or transmitting signals, such as cooperative sensing messages (CSMs).

The vehicle communication system 22 is configured to wirelessly communicate information between the one or more vehicles 12 and another vehicle. Further, the vehicle communication system 22 is configured to wirelessly communicate information between the one or more vehicles 12 and infrastructure or other vehicles. It should be understood that the vehicle communication system 22 may be integrated with the vehicle controller 18 (e.g., on a same circuit board with the vehicle controller 18 or otherwise a part of the vehicle controller 18) without departing from the scope of the present disclosure.

With continued reference to FIG. 1, the remote system 16 includes a remote system controller 26a in electrical communication with a remote system database 28 and a remote system communication system 30. In a non-limiting example, the remote system 16 is located in a server farm, datacenter, or the like, and connected to the internet using the remote system communication system 30. The remote system controller 26a includes at least one remote system processor 26b and a remote system non-transitory computer readable storage device or remote system media 26c. The description of the type and configuration given above for the vehicle controller 18 also applies to the remote system controller 26a. In some examples, the remote system controller 26a may differ from the vehicle controller 18 in that the remote system controller 26a is capable of a higher processing speed, includes more memory, includes more inputs/outputs, and/or the like. In a non-limiting example, the remote system processor 26b and remote system media 26c of the remote system controller 26a are similar in structure and/or function to the processor and the media of the vehicle controller 18, as described above.

The remote system database 28 is used to store data received from the one or more vehicles 12, as will be discussed in greater detail below. The remote system communication system 30 is used to communicate with external systems, such as, for example, the vehicle controller 18 via the vehicle communication system 22. In a non-limiting example, remote system communication system 30 is similar in structure and/or function to the vehicle communication system 22 of the vehicle system 14, as described above. In some examples, the remote system communication system 30 may differ from the vehicle communication system 22 in that the remote system communication system 30 is capable of higher power signal transmission, more sensitive signal reception, higher bandwidth transmission, additional transmission/reception protocols, and/or the like.

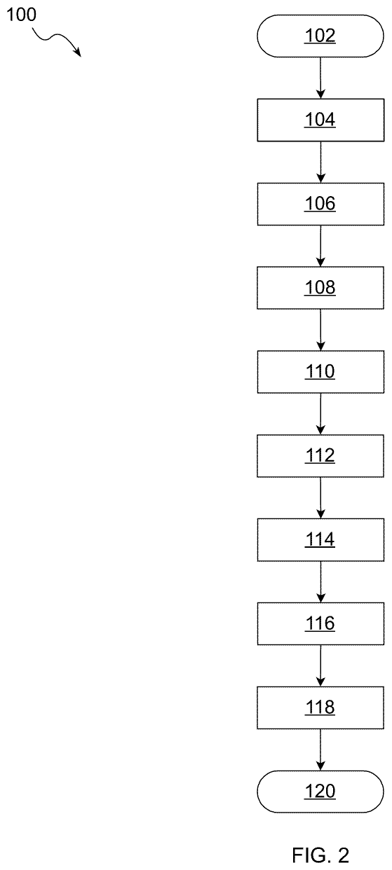

Referring to FIG. 2, a flowchart of the method 100 for fusing data from one or more vehicles is shown. The method 100 begins at block 102 and proceeds to block 104. At block 104, the vehicle controller 18 of the vehicle system 14 of each of the one or more vehicles 12 uses the one or more vehicle sensors 20 to capture sensor data of the environment surrounding each of the one or more vehicles 12. In a non-limiting example, the sensor data includes camera data of the environment. In another non-limiting example, the sensor data includes distance data such as, for example, LiDAR data, radar data, and/or the like. In an exemplary embodiment, after capturing the sensor data using the one or more vehicle sensors 20, the vehicle controller 18 fuses the sensor data captured by multiple sensors to form a detailed view of the environment. In a non-limiting example, the detailed view may include camera image data including one or more objects (e.g., other vehicles) and distance data aligned to the camera image data providing distances to the one or more objects. After block 104, the method 100 proceeds to block 106.

At block 106, the vehicle controller 18 identifies one or more features in the sensor data using a feature extraction algorithm. In the scope of the present disclosure, features are objects such as, for example, vehicles, pedestrians, traffic control devices (e.g., street signs, road markings, traffic lights, etc.), road edges, structures, environmental terrain, and/or the like. In the scope of the present disclosure, the feature extraction algorithm is a software algorithm configured to identify features in the sensor data.

In a non-limiting example, the feature extraction algorithm first pre-processes the sensor data to enhance relevant patterns while reducing noise. For example, if the sensor data comes from a LiDAR sensor, the feature extraction algorithm may filter out irrelevant points, such as those from sensor noise. In a non-limiting example, the feature extraction algorithm includes a data segmentation module, a feature descriptor module, and a feature classification module. The data segmentation module partitions the sensor data into regions of interest, often referred to as “clusters”, based on characteristics like spatial proximity or intensity. For example, data points corresponding to a nearby vehicle may be grouped together based on their spatial alignment and surface contours. The feature descriptor module then analyzes each cluster to generate distinctive characteristics, such as object heading, speed, location, dimensions, shape, or texture.

Once segmented and described, the feature classification module is used to extract features. For example, the feature classification module differentiates between pedestrians, vehicles, and other objects based on patterns in the sensor data clusters using rule-based and/or machine learning algorithms. After block 106, the method 100 proceeds to block 108.

At block 108, the vehicle controller 18 determines an importance level of the sensor data using a data importance classification machine learning model. In the scope of the present disclosure, the importance level indicates a criticality of the sensor data to the driving task. For example, sensor data about objects which are relatively far away from the one or more vehicles 12 has a relatively low importance level. Sensor data about objects which are relatively close to the one or more vehicles 12 has a relatively high importance level. In another example, sensor data about objects which are stationary has a relatively low importance level. Sensor data about objects which are in motion has a relatively high importance level. In another example, sensor data about objects which are moving away from the one or more vehicles 12 has a relatively low importance level. Sensor data about objects which are moving toward the one or more vehicles 12 has a relatively high importance level.

In an exemplary embodiment, the importance level is determined based at least in part on at least one of the following importance indicators: the one or more features identified in the sensor data at block 106, a sensor type of the sensor data (i.e., camera, LiDAR, radar, etc.), a road configuration in the sensor data (i.e., road type/location, intersection type, number of lanes, and/or the like), events occurring in the environment (e.g., hard braking events, road construction, etc.), and/or driving style of surrounding vehicles (i.e., based on speed, following distance, and/or the like). In an exemplary embodiment, the road configuration, events, and driving style are identified using rule-based or machine learning based algorithms based on the one or more features identified in the sensor data at block 106. In an exemplary embodiment, the importance indicators further include an important sensor type and/or an important feature determined by the remote system 16, as will be discussed in greater detail below.

In a non-limiting example, the data importance classification machine learning model includes multiple layers, including an input layer and an output layer, as well as one or more hidden layers. The input layer receives the sensor data captured at block 104 and the importance indicators as inputs. The inputs are then passed on to the hidden layers. Each hidden layer applies a transformation (e.g., a non-linear transformation) to the data and passes the result to the next hidden layer until the final hidden layer. The output layer produces the importance level of the sensor data.

To train the data importance classification machine learning model, a dataset of inputs and their corresponding the importance level of the sensor data is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to classify new input data.

After sufficient training of the data importance classification machine learning model, the algorithm is capable of determining the importance level of the sensor data based on the sensor data captured at block 104 and the importance indicators. By adjusting the weights between the nodes in each hidden layer during training, the algorithm “learns” to recognize patterns in the data that are indicative of the importance level. After block 108, the method 100 proceeds to block 110.

At block 110, the vehicle controller 18 generates tokenized data by tokenizing the sensor data based on the one or more features identified at block 106 and the importance level of the sensor data determined at block 108. In the scope of the present disclosure, tokenization is a process by which the sensor data and the one or more features are transformed into a simplified, encoded representation for privacy and efficiency. In an exemplary embodiment, the tokenization process includes representing the one or more features as one or more tokens. Each of the one or more tokens has multiple properties, including, for example, a unique identifier (i.e., a unique code for distinguishing between tokens), a token type identifier (i.e., a code denoting the feature identified by the token, e.g., a vehicle, a pedestrian, etc.), and a location (i.e., a coordinate location of the feature identified by the token in the environment).

It should be understood that the tokens may have additional properties, such as, for example, a heading of the feature identified by the token, a speed of the feature identified by the token, boundaries or edges of the feature identified by the token, and/or the like. In an exemplary embodiment, the token properties do not include identifying information such as, for example, vehicle color or license plate number.

Therefore, at block 110, the vehicle controller 18 generates the tokenized data based on the sensor data captured at block 104 and the one or more features identified at block 106. In an exemplary embodiment, the tokenized data is generated based at least in part on the importance level of the sensor data. In a non-limiting example, the size of the tokenized data is adjusted based on the importance level of the sensor data. For example, the size of the tokenized data may be increased by including more tokens and/or more token properties for each token. The size of the tokenized data may be decreased by including less tokens and/or less token properties for each token.

In an exemplary embodiment, the size of the tokenized data varies directly with the importance level of the sensor data. In other words, sensor data having a higher importance level will be tokenized such that the resulting tokenized data is larger (i.e., includes more information) than tokenized data resulting from the tokenization of sensor data having a lower importance level. In any case, the size of the tokenized data is smaller than the original size of the raw sensor data captured at block 104. After block 110, the method 100 proceeds to block 112.

At block 112, the vehicle controller 18 uses the vehicle communication system 22 to transmit the tokenized data to the remote system 16. In an exemplary embodiment, the tokenized data is further compressed (e.g., using an entropy-based compression algorithm) before transmission. Furthermore, at block 112, the remote system controller 26a uses the remote system communication system 30 to receive the tokenized data. After reception, the tokenized data is decompressed and stored in the remote system database 28. After block 112, the method 100 proceeds to block 114.

It should be understood that the above disclosure is applicable to each of the one or more vehicles 12, and that the vehicle system 14 of each of the one or more vehicles 12 may perform the method steps of blocks 104, 106, 108, 110, and 112. Therefore, each of the one or more vehicles 12 transmits tokenized data to the remote system 16.

At block 114, the remote system controller 26a detokenizes the tokenized data received at block 112 to generate detokenized data. In an exemplary embodiment, to detokenize the tokenized data, the remote system controller 26a uses a database of known features stored in the remote system database 28. In a non-limiting example, the remote system database 28 includes a list of token type identifier codes and the corresponding token types (e.g., vehicle, pedestrian, etc.). Furthermore, based on the token properties received with each token (e.g., the location of the feature identified by the token, the heading of the feature identified by the token, the speed of the feature identified by the token, the boundaries or edges of the feature identified by the token, and/or the like), the remote system controller 26a is able to create a reconstructed detailed view of the environment similar to the detailed view of the environment discussed above in reference to block 104.

In a non-limiting example, the reconstructed detailed view does not include personal or identifying information about the features (e.g., vehicles, pedestrians, and/or the like) in the environment. Furthermore, the amount of detail in the reconstructed detailed view depends on the importance level of the sensor data upon which the reconstructed detailed view is based, as discussed above. After block 114, the method 100 proceeds to block 116.

At block 116, the remote system controller 26a combines the detokenized data received from multiple of the one or more vehicles 12 to aggregate combined detokenized data. In an exemplary embodiment, the remote system controller 26a stitches together (i.e., fuses) the detokenized data from multiple vehicles to provide a more complete view of the environment. In a non-limiting example, the remote system controller 26a fuses the detokenized data based on common features in the tokenized data from multiple vehicles. In an exemplary embodiment, the remote system controller 26a uses a data fusion machine learning model trained to fuse data captured in various environmental conditions from multiple vehicles. In a non-limiting example, the data fusion machine learning model is trained to fuse data including various road configurations (i.e., road type/location, intersection type, number of lanes, and/or the like).

In a non-limiting example, the data fusion machine learning model includes multiple layers, including an input layer and an output layer, as well as one or more hidden layers. The input layer receives the detokenized data received from multiple of the one or more vehicles 12 as inputs. The inputs are then passed on to the hidden layers. Each hidden layer applies a transformation (e.g., a non-linear transformation) to the data and passes the result to the next hidden layer until the final hidden layer. The output layer produces the combined detokenized data.

To train the data fusion machine learning model, a dataset of inputs and their corresponding the combined detokenized data is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to process new input data.

After sufficient training of the data fusion machine learning model, the algorithm is capable of producing the combined detokenized data based on the detokenized data received from multiple of the one or more vehicles 12 including various road configurations (i.e., road type/location, intersection type, number of lanes, and/or the like). In another exemplary embodiment, the data fusion machine learning model is produced by fine-tuning a pre-trained general or “backbone” machine learning model. After block 116, the method 100 proceeds to block 118.

At block 118, the remote system controller 26a identifies the important sensor type and the important feature type based on the combined detokenized data. In the scope of the present disclosure, the important sensor type is one of the one or more vehicle sensors 20 which is deemed to be most important for gathering relevant information about the environment. For example, in an environment containing many other vehicles, a ranging sensor (e.g., a LiDAR sensor) may be the important sensor type as the ranging sensor allows for determination of clearance to the other vehicles. In another example, in an environment having a complex road configuration (e.g., many traffic signals, many lanes of travel, complex intersection, etc.), a perception sensor (e.g., a camera) may be the important sensor type as the perception sensor allows for recognition of lane lines, traffic light phase states, and the like.

In the scope of the present disclosure, the important feature type is a type of feature (e.g., vehicle, pedestrian, structure, traffic control infrastructure, etc.) which is deemed to be most important for gathering relevant information about the environment. For example, in an environment containing many other vehicles, a vehicle feature type may be the important feature type. In another example, in an environment having a complex road configuration (e.g., many traffic signals, many lanes of travel, complex intersection, etc.), a traffic control infrastructure feature type may be the important feature type.

In an exemplary embodiment, to determine the important senor type and the important feature type, the remote system controller 26a uses a sensor and feature importance classification machine learning model trained to identify the important sensor type and the important feature based at least in part on the combined detokenized data.

In a non-limiting example, the sensor and feature importance classification machine learning model includes multiple layers, including an input layer and an output layer, as well as one or more hidden layers. The input layer receives the combined detokenized data as inputs. The inputs are then passed on to the hidden layers. Each hidden layer applies a transformation (e.g., a non-linear transformation) to the data and passes the result to the next hidden layer until the final hidden layer. The output layer produces the important sensor type and the important feature.

To train the sensor and feature importance classification machine learning model, a dataset of inputs and their corresponding the important sensor type and the important feature is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to process new input data.

After sufficient training of the sensor and feature importance classification machine learning model, the algorithm is capable of determining the important sensor type and the important feature based on the combined detokenized data. By adjusting the weights between the nodes in each hidden layer during training, the algorithm “learns” to recognize patterns in the combined detokenized data that are indicative of the important sensor type and the important feature. In another exemplary embodiment, the sensor and feature importance classification machine learning model is produced by fine-tuning a pre-trained general or “backbone” machine learning model.

In a non-limiting example, a single important sensor type and important feature are determined for a particular geographical area (e.g., a one square-kilometer area). In another non-limiting example, an important sensor type and an important feature are determined individually for each of the one or more vehicles 12. In a non-limiting example, the important sensor type and important feature are applicable for a limited predetermined timeframe (e.g., one minute) before the important sensor type and important feature are re-evaluated based on changing environmental conditions.

Furthermore, at block 118, the important sensor type and the important feature are transmitted to each of the one or more vehicles 12 using the remote system communication system 30. As discussed above in reference to block 108, the important sensor type and the important feature are used as importance indicators to determine the importance level of the sensor data collected by the one or more vehicles 12. In another example, the important sensor type and/or the important feature are used by vehicle controller 18 of the one or more vehicles 12 to adjust a path planning algorithm of an automated driving system or an advanced driver assistance system (ADAS) of the one or more vehicles 12. In another example, the one or more tokens from each of the one or more vehicles 12 are distributed to each of the one or more vehicles 12 (either directly peer-to-peer or by relay though the remote system 16) such that each of the one or more vehicles 12 may detokenize and create a reconstructed detailed view of the environment. After block 118, the method 100 proceeds to enter a standby state at block 120.

In an exemplary embodiment, the method 100 repeatedly exits the standby state 120 and restarts the method 100 at block 102. In a non-limiting example, the method exits the standby state 120 and restarts on a timer, for example, every three hundred milliseconds.

The system 10 and method 100 of the present disclosure offer several advantages. Using the tokenization process of the system 10 and method 100, the bandwidth required for data transfer between the one or more vehicles 12 and the remote system 16 is reduced and the privacy of other road users is protected. Furthermore, by identifying the important sensor type and the important feature and transmitting that information to the one or more vehicles 12, the process of data acquisition, tokenization, and transfer is further optimized to focus on the most relevant data.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for fusing data from one or more vehicles, the method comprising:
capturing sensor data using one or more vehicle sensors;
transmitting the sensor data to a remote system, wherein the sensor data is transmitted as tokenized data based at least in part on one or more features identified in the sensor data;
receiving the tokenized data from the one or more vehicles using the remote system; and
fusing the tokenized data from the one or more vehicles using the remote system.

2. The method of claim 1, wherein transmitting the sensor data further comprises:
identifying one or more features in the sensor data using a feature extraction algorithm; and
tokenizing the sensor data based at least in part on the one or more features.

3. The method of claim 2, wherein tokenizing the sensor data further comprises:
determining an importance level of the sensor data using a data importance classification machine learning model; and
tokenizing the sensor data based at least in part on the importance level of the sensor data.

4. The method of claim 3, wherein determining the importance level further comprises:
determining the importance level of the sensor data using the data importance classification machine learning model based at least in part on at least one of: the one or more features in the sensor data, a sensor type of the sensor data, and a road configuration in the sensor data.

5. The method of claim 3, wherein tokenizing the sensor data based at least in part on the importance level of the sensor data further comprises:
tokenizing the sensor data based at least in part on the importance level of the sensor data, wherein a size of the tokenized data varies directly with the importance level of the sensor data.

6. The method of claim 3, wherein receiving the tokenized data further comprises:
generating detokenized data by detokenizing the tokenized data using a database of known features.

7. The method of claim 6, wherein fusing the tokenized data further comprises:
combining the detokenized data received from multiple vehicles to aggregate combined detokenized data;
identifying at least one of: an important sensor type and an important feature based at least in part on the combined detokenized data; and
transmitting at least one of: the important sensor type and the important feature to the one or more vehicles.

8. The method of claim 7, wherein combining the detokenized data further comprises:
combining the detokenized data received from multiple vehicles using a data fusion machine learning model trained to fuse data captured in various environmental conditions from multiple vehicles.

9. The method of claim 7, wherein identifying at least one of: the important sensor type and the important feature based at least in part on the combined detokenized data further comprises:
identifying at least one of: the important sensor type and the important feature based at least in part on the combined detokenized data using a sensor and feature importance classification machine learning model trained to identify the important sensor type and the important feature based at least in part on the combined detokenized data.

10. The method of claim 7, wherein determining the importance level further comprises:
determining the importance level of the sensor data using the data importance classification machine learning model based at least in part on at least one of: the important sensor type and the important feature.

11. A system for fusing data from one or more vehicles, the system comprising:
one or more vehicle systems, each of the one or more vehicle systems including:
one or more vehicle sensors;
a vehicle communication system; and
a vehicle controller in electrical communication with the one or more vehicle sensors and the vehicle communication system, wherein the vehicle controller is programmed to:
capture sensor data using one or more vehicle sensors; and
transmit the sensor data to a remote system using the vehicle communication system, wherein the sensor data is transmitted as tokenized data based at least in part on one or more features identified in the sensor data.

12. The system of claim 11, further comprising the remote system including:
a remote system communication system; and
a remote system controller in electrical communication with the remote system communication system, wherein the remote system controller is programmed to:
receive the tokenized data from the one or more vehicles using the remote system communication system; and
fuse the tokenized data from the one or more vehicles.

13. The system of claim 12, wherein to transmit the sensor data, the vehicle controller is further programmed to:
identify one or more features in the sensor data using a feature extraction algorithm;
determine an importance level of the sensor data using a data importance classification machine learning model based at least in part on at least one of: the one or more features in the sensor data, a sensor type of the sensor data, and a road configuration in the sensor data; and
tokenize the sensor data based at least in part on the importance level of the sensor data, wherein a size of the tokenized data varies directly with the importance level of the sensor data.

14. The system of claim 13, wherein to fuse the tokenized data, the remote system controller is further programmed to:
generate detokenized data by detokenizing the tokenized data using a database of known features;
combine the detokenized data received from multiple vehicles to aggregate combined detokenized data;
identify at least one of: an important sensor type and an important feature based at least in part on the combined detokenized data; and
transmit at least one of: the important sensor type and the important feature to the one or more vehicle systems using the remote system communication system.

15. The system of claim 14, wherein to combine the detokenized data, the remote system controller is further programmed to:
combine the detokenized data received from multiple vehicles using a data fusion machine learning model trained to fuse data captured in various environmental conditions from multiple vehicles.

16. The system of claim 15, wherein to identify at least one of: the important sensor type and the important feature based at least in part on the combined detokenized data, the remote system controller is further programmed to:
identify at least one of: the important sensor type and the important feature based at least in part on the combined detokenized data using a sensor and feature importance classification machine learning model trained to identify the important sensor type and the important feature based at least in part on the combined detokenized data.

17. The system of claim 16, wherein to determine the importance level, the vehicle controller is further programmed to:
receive at least one of: the important sensor type and the important feature from the remote system using the vehicle communication system; and
determine the importance level of the sensor data using the data importance classification machine learning model based at least in part on at least one of: the important sensor type and the important feature.

18. A method for fusing data from one or more vehicles, the method comprising:
capturing sensor data using one or more vehicle sensors;
identifying one or more features in the sensor data using a feature extraction algorithm;
determining an importance level of the sensor data using a data importance classification machine learning model based at least in part on at least one of: the one or more features in the sensor data, a sensor type of the sensor data, and a road configuration in the sensor data and based at least in part on at least one of: an important sensor type and an important feature received from a remote system;
generating tokenized data by tokenizing the sensor data based at least in part on the importance level of the sensor data;
transmitting the tokenized data to the remote system;
identifying at least one of: the important sensor type and the important feature based at least in part on the tokenized data using the remote system; and
transmitting at least one of: the important sensor type and the important feature to the one or more vehicles using the remote system.

19. The method of claim 18, wherein generating the tokenized data further comprises:
tokenizing the sensor data based at least in part on the importance level of the sensor data, wherein a size of the tokenized data varies directly with the importance level of the sensor data.

20. The method of claim 19, wherein identifying at least one of: the important sensor type and the important feature further comprises:
generating detokenized data by detokenizing the tokenized data using a database of known features;
combining the detokenized data received from multiple vehicles to aggregate combined detokenized data; and
identifying at least one of: the important sensor type and the important feature using a sensor and feature importance classification machine learning model trained to identify the important sensor type and the important feature based at least in part on the combined detokenized data.
